(19) United States
(12) Patent Application Publication
(10) Pub. No.: US 2005/0026734 A1
(43) Pub. Date: Feb. 3, 2005

(54) Tandem axle pinion shaft subassembly

(76) Inventors: James Ziech, Kalamazoo, MI (US); Leo Wenstrup, Portage, MI (US)

Correspondence Address: Dykema Gossett, Suite 300, 39577 Woodward Avenue, Bloomfield Hills, MI, 48304-2820, US

(21) Appl. No.: 10/479,652

(22) PCT Filed: May 31, 2002
(86) PCT No.: PCT/US02/17326

(30) Foreign Application Priority Data
Jan. 6, 2001 (US) 60295483

(51) Int. Cl. F16H 48/06

(52) U.S. Cl. 475/246

(57) ABSTRACT

A pinion shaft subassembly for a tandem drive axle assembly is provided. The preassembled subassembly includes a bearing cage, bearings disposed within the bearing cage, a pinion shaft disposed about an axis and supported on the bearings, and a driven gear disposed about the pinion shaft. The bearing cage defines a mounting flange that extends radially outwardly and is configured to mount to a corresponding mounting flange of a drive axle housing. The flange is configured such that the subassembly is installed in the drive axle housing from the rear of the housing rather than the forward end. As a result, the housing may be made of a unitary construction.

### BACKGROUND OF THE INVENTION

1. Field of the Invention

This invention relates to drive axle assemblies and, in particular, to a pinion shaft subassembly for use in a drive axle assembly.

2. Disclosure of Related Art

A conventional tandem axle assembly includes forward and rear drive axle assemblies. The forward and rear drive axle assemblies each include a pair of axle half shafts extending therefrom on which one or more wheels of a vehicle are mounted. Each of the forward and rear drive axle assemblies further includes a differential gear set that allows the vehicle wheels on each axle assembly to rotate at different speeds. Further, one of the forward and rear drive axle assemblies generally includes means, such as an inter-axle differential, for dividing power between the forward and rear drive axle assemblies.

The differential gear sets in the forward and rear drive axle assemblies each include a pinion gear in mesh with a ring gear (which in turn drives a plurality of bevel gears to cause rotation of the axle half shafts). In the axle assembly containing the power dividing means, the pinion gear is supported by a pinion shaft that rotates in response to one or more gears driven by the power dividing means. The pinion shaft is itself supported by bearings supported within a pinion bearing cage. As shown in U.S. Pat. No. 5,267,489, the entire disclosure of which is incorporated herein by reference, the pinion bearing cage, bearings, pinion shaft, and a driven gear may be combined as a subassembly for installation in the drive axle assembly. The pinion bearing cage includes a mounting flange that may be coupled by one or more fasteners to a corresponding mounting flange in a housing for the drive axle assembly and may be preassembled with the bearings preadjusted as a subassembly.

A drive axle assembly incorporating the above-described subassembly has several advantages as compared to prior art drive axle assemblies. The drive axle assembly still suffers from a significant drawback, however. In particular, the housing containing the pinion shaft subassembly and the power dividing means is composed of multiple components that must be coupled together. As a result, the cost and time required for manufacturing and assembling the drive axle assembly is relatively high.

There is thus a need for a pinion shaft subassembly for a drive axle assembly that will minimize or eliminate one or more of the above-mentioned deficiencies and still allow the preassembly of the pinion shaft subassembly.

### SUMMARY OF THE INVENTION

The present invention provides a pinion shaft subassembly for a drive axle assembly of a vehicle.

A pinion shaft subassembly in accordance with the present invention includes a bearing cage disposed about a first axis. The bearing cage defines a mounting flange that extends radially outwardly and is configured to mount to a corresponding mounting flange of a drive axle housing. The subassembly further includes bearings disposed within the bearing cage. Finally, the subassembly includes a pinion shaft supported on the bearings within the bearing cage. The pinion shaft has a first axial end that extends in a first (or forward) axial direction and a second axial end that extends from the bearing cage in a second (or rearward) axial direction. The pinion shaft is configured to support a pinion gear proximate the second axial end of the pinion shaft. In accordance with the present invention, a first side of the mounting flange of the bearing cage faces in the first (or forward) axial direction and also faces the corresponding mounting flange of the drive axle housing upon installation of the bearing cage in the drive axle housing.

A drive axle assembly incorporating a pinion shaft subassembly in accordance with the present invention has a significant advantage as compared to conventional drive axle assemblies. In particular, the relative positioning of the mounting flanges allows the inventive subassembly to be installed from the rear of the drive axle assembly (i.e., in a forward direction). As a result, the housing in which the power dividing means and the subassembly are disposed may be made of a unitary (i.e., one-piece) construction thereby reducing manufacturing and assembly time and cost for the drive axle assembly.

These and other features and objects of this invention will become apparent to one skilled in the art from the following detailed description and the accompanying drawings illustrating features of this invention by way of example.

### BRIEF DESCRIPTION OF THE DRAWINGS

FIG. 1 is a cross-sectional view of a drive axle assembly for a tandem axle assembly having a pinion shaft subassembly in accordance with the present invention.

FIG. 2 is a perspective view of a pinion shaft subassembly in accordance with the present invention.

### DETAILED DESCRIPTION OF THE PREFERRED EMBODIMENT

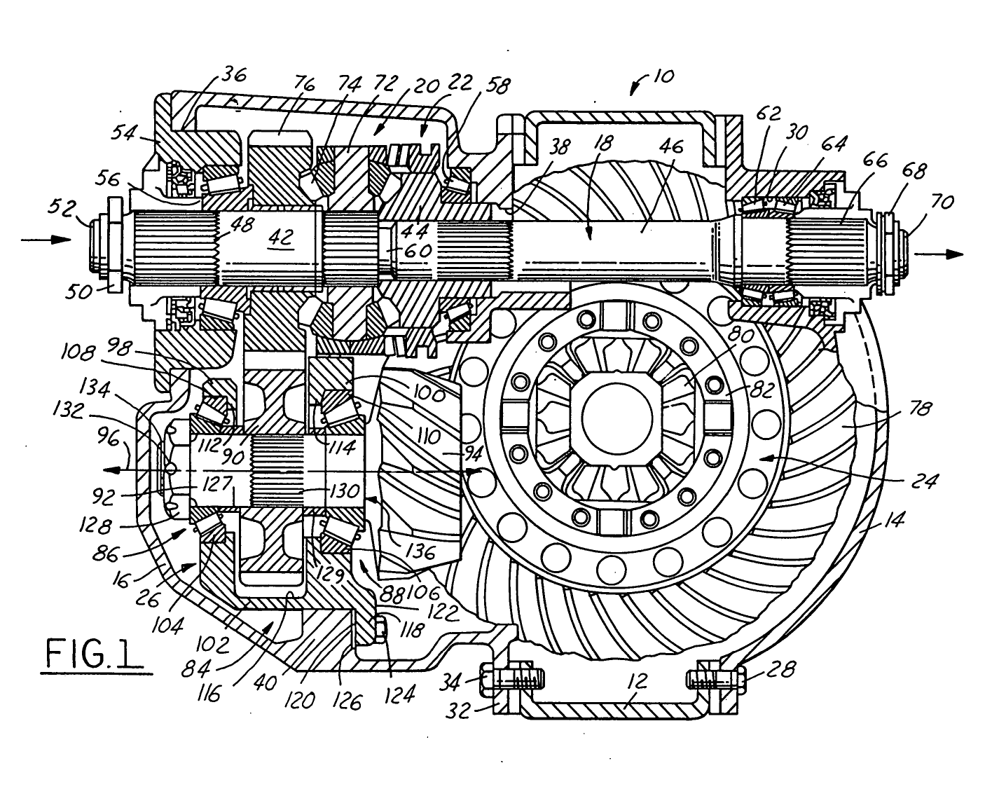

Referring now to the drawings wherein like reference numerals are used to identify identical components in the various views, FIG. 1 illustrates a drive axle assembly 10 in accordance with the present invention. Axle assembly 10 is particularly adapted for use in a tandem axle assembly for a heavy truck. It should be understood, however, that axle assembly 10 may find use in tandem axle assemblies found on a variety of conventional vehicles. Axle assembly has a forward end (the left side in FIG. 1) and a rear end (the right side in FIG. 1) and may include the following elements: a differential housing 12; a rear housing 14; a forward housing 16; a drive shaft assembly 18; means, such as inter-axle differential 20, for dividing power between assembly 10 and another drive axle assembly (not shown) of the tandem axle assembly; a differential locking device, such as clutch 22; and a differential gear assembly 24. Assembly 10 also includes a pinion shaft subassembly 26 in accordance with the present invention.

Housings 12, 14, 16 provide structural support for the other components of assembly 10. Housings 12, 14, 16 also protect the other components of assembly 10 from foreign objects and elements. Housings 12, 14, 16 may be made from conventional metals and metal alloys such as steel.

Housings 12, 14 are configured to receive differential gear assembly 24 and may be coupled together using conventional fasteners 28 such as screws or bolts. Housing 12 defines a pair of openings (not shown) from which axle half shafts extend. The axle half shafts may support the vehicle wheels. Alternatively, the vehicle wheels may be supported directly on the axle housing. Housing 14 defines an opening 30 sized relative to components of drive shaft assembly 18 so as to allow drive shaft assembly 18 to pass therethrough.

Housing 16 is configured to house inter-axle differential 20 and pinion shaft subassembly 26. Housing 16 may be coupled to housing 12 at a flange 32 using conventional fasteners 34 such as screws or bolts. Housing 16 includes a pair of openings 36, 38 sized relative to components of drive shaft assembly 18 so as to allow drive shaft assembly 18 to pass through housing 16. Housing 16 further defines an inwardly extending mounting flange 40 for a purpose described hereinbelow. In accordance with the present invention, housing 16 is of unitary (i.e., one-piece) construction. The present invention therefore reduces manufacturing and assembly time and cost as compared to conventional drive axle assemblies in which the housing for the power dividing means and pinion shaft subassembly is composed of multiple members that must be coupled together.

Drive shaft assembly 18 is provided to transmit power from a power input shaft (not shown) at the forward end of drive axle assembly 10 to an intermediate drive shaft (not shown) disposed at the read end of assembly 10 and extending between assembly 10 and another drive axle assembly. Drive shaft assembly 18 is conventional in the art and may include an input shaft 42, a gear 44, and an output shaft 46.

Input shaft 42 is provided to transmit power from the power input shaft (not shown) to inter-axle differential 20 and is conventional in the art. Input shaft 42 is driven by the power input shaft through a conventional input yoke (not shown). The input yoke may be splined to the forward end of input shaft 42 on splines 48 and may be retained thereon by a nut 50 and a washer which are disposed about a threaded stud 52 that extends from shaft 42 and is integral therewith. A cap 54 is disposed about the input yoke and is received within opening 36 in housing 16. Shaft 42 is journalled for rotation within an opening in cap 54 by bearings 56 disposed within the opening.

Gear 44 transmits power received from inter-axle differential 20 to output shaft 46. Gear 44 is conventional in the art and may be made from conventional metals and metal alloys. Gear 44 is disposed about shaft 46 near the forward end of shaft 46 and may be coupled thereto by mating splines (not shown) on gear 44 and shaft 46. Gear 44 is journalled for rotation within housing 16 by bearings 58.

Output shaft 46 is provided to transmit a portion of the power provided by input shaft 42 to the intermediate drive shaft (not shown) extending between assembly 10 and another drive axle assembly. Shaft 46 is coaxially disposed relative to input shaft 42 and includes a pilot portion 60 at its forward end on which input shaft 42 is journalled. Shaft 46 extends through openings 38, 30 in housings 16, 14, respectively, and is journalled within opening 30 of housing 14 by bearings 62, 64. Shaft 46 transmits power to the intermediate drive shaft through a conventional output yoke (not shown). The output yoke may be splined to the rear end of output shaft 46 on splines 66 and may be retained thereon by a nut 68 and a washer which are disposed about a threaded stud 70 that extends from shaft 46 and is integral therewith.

Inter-axle differential 20 is provided to divide power between assembly 10 and another drive axle assembly and is conventional in the art. Differential 20 may include a spider 72, bevel gears 74, and an input gear 76.

Spider 72 provides a mounting arrangement for bevel gears 74 and is conventional in the art. Spider 72 may be coupled to input shaft 46 for rotation therewith using a spline connection or in other ways customary in the art. Alternatively, spider 72 may be made integral with input shaft 46.

Bevel gears 74 are provided to divide and transfer torque from input shaft 46 to input gear 76 (for driving pinion shaft subassembly 26 of drive axle assembly 10) and to gear 44 of drive shaft assembly 18 (for driving another drive axle assembly). Gears 74 are conventional in the art and may be made from conventional metals and metal alloys. Gears 74 are mounted on spider 72 for rotation with spider 72 and input shaft 42. The teeth on gears 74 engage corresponding teeth on gear 44 of drive shaft assembly 18 and on input gear 76.

Input gear 76 transfers torque from inter-axle differential 20 (and indirectly from input shaft 42 of drive shaft assembly 18) to pinion shaft subassembly 26. Gear 76 is also conventional in the art and may be made from conventional metals and metal alloys. Gear 76 is disposed about input shaft 42 and is freely rotatable thereon, being journalled on shaft 42 by bearings (not shown). Gear 76 includes a first set of teeth disposed on a rear planar surface that engage the teeth of bevel gears 74. Gear 76 further includes a second set of teeth disposed about the radial periphery of gear 76 for a purpose described hereinbelow.

Clutch 22 is provided to selectively lock differential 20 and is conventional in the art. In the illustrated embodiment, clutch 22 comprises a conventional sliding dog clutch that may be engaged by shifting a clutch member with a first set of teeth into engagement with a clutch member having a second set of teeth using a shifting fork.

Differential gear assembly 24 is provided to enable the wheels (not shown) on opposite sides of drive axle assembly 10 to rotate at different speeds. Assembly 24 is conventional in the art and includes a ring gear 78 and a conventional bevel gear set 80 mounted within a differential carrier 82. Gear assembly 24 is substantially disposed within differential housing 12.

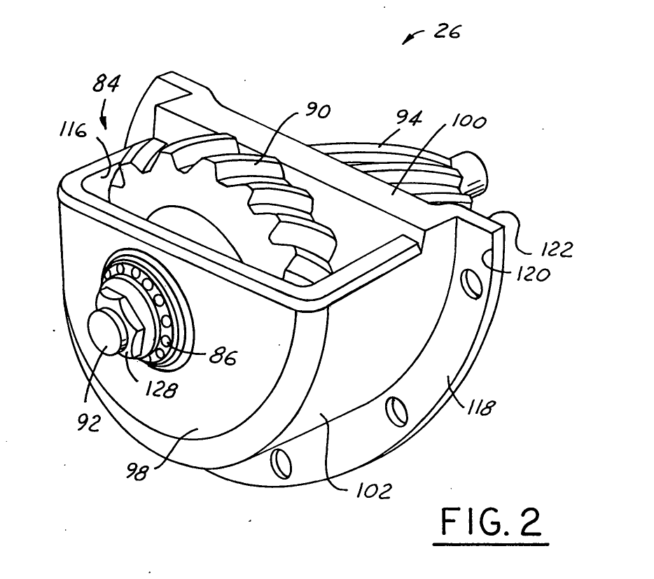

Pinion shaft subassembly 26 transfers torque from drive shaft assembly 18 to differential gear assembly 24. Referring to FIGS. 1 and 2, subassembly 26 will be now be described in greater detail. Subassembly 26 may include a bearing cage 84, bearings 86, 88, a driven gear 90, a pinion shaft 92, and a pinion gear 94.

Bearing cage 84 provides structural support and positions other components of subassembly 26. Cage 84 may be made from conventional metals and metal alloys and is disposed about an axis 96 extending through pinion shaft 92. Cage 84 includes first, second, and third walls 98, 100, 102. Walls 98, 100 extend radially and are spaced from one another while wall 102 extends axially and connects walls 98, 100. Walls 98, 100, 102 may be integral with one another or may be separate parts coupled together using conventional fasteners. Walls 98, 100 define axially aligned openings 104, 106 configured to receive bearings 86, 88. In particular, openings 104, 106 may be sized relative to the cups 108, 110 of the corresponding bearings 86, 88 and cups 108, 110 may bear against shoulders 112, 114 defined in walls 98, 100. Walls 98, 100, 102 further define a gear-receiving cavity 116 (on either side of which are located openings 104, 106) configured to receive driven gear 90. This configuration offers stronger support and allows more accurate positioning of gear 90 as compared to many conventional drive axle assemblies in which the driven gear is cantilevered on one side of both sets of bearings.

Bearing cage 84 further defines a mounting flange 118 that is disposed proximate one axial end of cage 84 and extends radially outwardly from wall 102. Flange 84 has a first (or forward) side 120 facing in a first (or forward) axial direction (to the left in FIG. 1) and a second (or rear) side 122 facing in a second (or rearward), and opposite, axial direction (to the right in FIG. 1). In accordance with the present invention, side 120 of flange 118 faces the corresponding mounting flange 40 on housing 16. Subassembly 26 may then be assembled within drive axle assembly 10 by moving subassembly 26 in the first (or forward) axial direction (to the left in FIG. 1) and coupling flanges 40, 118 through, for example, one or more conventional fasteners 124 such as screws or bolts. This configuration represents an improvement as compared to conventional subassemblies and drive axle assemblies. Because the subassembly 26 is installed from the rear end of housing 16 as opposed to the forward end of housing 16, there is no need for a separate cover piece to allow entry of, and access to, subassembly 26 within housing 16. As a result, housing 16 may be unitary in construction thereby reducing manufacturing and assembly time and cost associated with housing 16 and assembly 10. The inventive subassembly 26 also enables relatively easy adjustment of the position of pinion gear 94 relative to ring gear 78 by using a shim pack 126 disposed between flanges 40, 118 to adjust the axial position of subassembly 26.

Bearings 86, 88 enable rotation of pinion shaft 92 relative to bearing cage 84. Bearings 86, 88 are conventional in the art and may comprise tapered roller bearings. Bearings 86, 88 are disposed within openings 104, 106 of walls 98, 100 of cage 84. Bearings 86 are retained within opening 104 between a nut 128 on pinion shaft 92 and shoulder 112. Bearings 88 are retained within opening 106 between shoulder 114 and pinion gear 94. Spacers 129, 131 may be disposed between bearings 86, 88 and each side of gear 90. The bearing preload may be easily adjusted using one of spacers 129, 131. The preload adjustment of bearings 86, 88 in subassembly 26 is more easily accomplished as compared to preload adjustment in conventional drive axle assemblies due to improved access and ease of handling subassembly 26. Further, bearings 86, 88 may be serviced without replacing carrier 82.

Driven gear 90 transmits torque from input gear 76 of inter-axle differential 20 to pinion shaft 92. Driven gear 90 may comprise a helical gear having teeth disposed about its radial periphery which engage corresponding teeth on input gear 76. Gear 90 may be drivingly coupled to shaft 92 through axially-extending splines 130 on shaft 92.

Pinion shaft 92 transmits torque to pinion gear 94 and is conventional in the art. Shaft 92 is disposed about axis 96 and is supported for rotation within openings 104, 106 of cage 84 by bearings 86, 88. A first (or forward) axial end 132 of shaft 92 may extend from opening 104 in a first axial direction (to the left in FIG. 1) and may define an integral threaded shank 134 configured to receive nut 130. A second (or rear) axial end 136 of shaft 92 extends from opening 106 in a second axial direction (to the right in FIG. 1) and is configured to receive pinion gear 94 thereon.

Pinion gear 94 transmits torque to ring gear 78 of differential gear assembly 24 and is also conventional in the art. Pinion gear 94 may comprise a hypoid gear and may be coupled to end 136 of shaft 92 using a spline connection or in other ways customary in the art. Pinion gear 94 is supported within assembly 10 solely by shaft 92. This configuration represents an advantage as compared to many conventional drive axle assemblies which include a pilot web and pilot bearing supporting the rear end of pinion gear 94. Elimination of the pilot web and bearing reduces material and manufacturing costs.

As set forth hereinabove, the present invention represents a significant improvement as compared to conventional pinion drive shaft subassemblies and drive axle assemblies. Because the inventive subassembly 26 is configured to be installed from the rear end of housing 16, housing 16 may be made of a unitary construction thereby reducing manufacturing and assembly time and cost as compared to conventional assemblies.

While the invention has been particularly shown and described with reference to the preferred embodiments thereof, it is well understood by those skilled in the art that various changes and modifications can be made in the invention without departing from the spirit and scope of the invention.

1. A pinion shaft subassembly for a drive axle assembly, comprising:
a bearing cage disposed about a first axis, said bearing cage defining a mounting flange that extends radially outwardly and is configured to mount to a corresponding mounting flange of a drive axle housing;
bearings disposed within said bearing cage; and,
a pinion shaft supported on said bearings, said pinion shaft having a first axial end extending in a first axial direction and a second axial end extending from said bearing cage in a second axial direction, said pinion shaft configured to support a pinion gear proximate said second axial end;
wherein a first side of said mounting flange of said bearing cage faces in said first axial direction and also faces said corresponding mounting flange of said drive axle housing upon installation of said bearing cage in said drive axle housing.

2. The pinion shaft subassembly of claim 1, further comprising a driven gear coupled to said pinion shaft and received within a gear-receiving cavity defined in said bearing cage, said driven gear configured to engage an input gear.

3. The pinion shaft subassembly of claim 1, further comprising a spacer disposed between said bearings.

4. The pinion shaft subassembly of claim 1, further comprising a fastener extending through said mounting flange of said bearing cage in said first axial direction and configured to be received within said mounting flange of said drive axle housing.

5. The pinion shaft subassembly of claim 1 wherein said bearing cage includes first and second walls axially spaced from one another and a third wall extending axially between said first and second walls, said first, second, and third walls defining a gear-receiving cavity and said first and second walls defining axially aligned openings on either side of said gear-receiving cavity, said first and second openings configured to receive said bearings.

6. The pinion shaft subassembly of claim 1 wherein said drive axle assembly comprises a forward axle assembly of a tandem drive axle assembly.

7. A pinion shaft subassembly for a drive axle assembly, comprising:
a bearing cage disposed about a first axis, said bearing cage defining a gear-receiving cavity and first and second axially aligned bearing openings disposed on either side of said cavity, said bearing cage further defining a mounting flange that extends radially outwardly and is configured to mount to a corresponding mounting flange of a drive axle housing;
bearings disposed within said first and second bearing openings in said bearing cage; and,
a pinion shaft supported on said bearings, said pinion shaft having a first axial end extending in a first axial direction and a second axial end extending from said bearing cage in a second axial direction, said pinion shaft configured to support a pinion gear proximate said second axial end; and,
a driven gear coupled to said pinion shaft and disposed within said gear-receiving cavity, said driven gear configured to engage an input gear;
wherein a first side of said mounting flange of said bearing cage faces in said first axial direction and also faces said corresponding mounting flange of said drive axle housing upon installation of said bearing cage in said drive axle housing.

8. The pinion shaft subassembly of claim 7, further comprising a spacer disposed between said bearings.

9. The pinion shaft subassembly of claim 7, further comprising a fastener extending through said mounting flange of said bearing cage in said first axial direction and configured to be received within said mounting flange of said drive axle housing.

10. The pinion shaft subassembly of claim 7 wherein said bearing cage includes first and second walls axially spaced from one another and a third wall extending axially between said first and second walls, said first, second, and third walls defining said gear-receiving cavity and said first and second walls defining said axially aligned openings on either side of said gear-receiving cavity.

11. The pinion shaft subassembly of claim 7 wherein said drive axle assembly comprises a forward axle assembly of a tandem drive axle assembly.

12. A drive axle assembly for a tandem drive axle, comprising:
a first housing;
a ring gear disposed within said first housing;
a second housing coupled to said first housing;
a pinion gear disposed within said second housing and in engagement with said ring gear;
a pinion shaft subassembly disposed within said second housing, said subassembly including:
a bearing cage disposed about a first axis, said bearing cage defining a mounting flange that extends radially outwardly and is configured to mount to a corresponding mounting flange of said second housing;
bearings disposed within said bearing cage; and
a pinion shaft supported on said bearings, said pinion shaft having a first axial end extending in a first axial direction and a second axial end extending from said bearing cage in a second axial direction, said pinion shaft configured to support said pinion gear proximate said second axial end;
wherein a first side of said mounting flange of said bearing cage faces in said first axial direction and also faces said corresponding mounting flange of said second housing.

13. The drive axle assembly of claim 12 wherein said second housing is unitary in construction.

14. The drive axle assembly of claim 12 wherein said pinion gear is supported within said second housing solely by said pinion shaft.

15. The drive axle assembly of claim 12, further comprising a shim pack disposed between said one side of said mounting flange of said bearing cage and said corresponding mounting flange of said second housing.

16. The drive axle assembly of claim 12, further comprising a driven gear coupled to said pinion shaft and received within a gear-receiving cavity defined in said bearing cage, said driven gear configured to engage an output gear.

17. The drive axle assembly of claim 12, further comprising a spacer disposed between said bearings.

18. The drive axle assembly of claim 12, further comprising a fastener extending through said mounting flange of said bearing cage in said first axial direction and configured to be received within said mounting flange of said second housing.

19. The drive axle assembly of claim 12 wherein said bearing cage includes first and second walls axially spaced from one another and a third wall extending axially between said first and second walls, said first, second, and third walls defining a gear-receiving cavity and said first and second walls defining axially aligned openings on either side of said gear-receiving cavity, said first and second openings configured to receive said bearings.

20. The drive axle assembly of claim 12 wherein said drive axle assembly comprises a forward axle assembly of a tandem drive axle assembly.
